(19) United States
(12) Patent Application Publication
(10) Pub. No.: US 2011/0297525 A1
(43) Pub. Date: Dec. 8, 2011

(54) DUSTPROOF PRESS KEY STRUCTURE

(75) Inventor: Ching-Cheng TSAI, Taipei Hsien (TW)

(73) Assignee: Chicony Electronics Co., Ltd.

(21) Appl. No.: 12/878,855

(22) Filed: Sep. 9, 2010

(30) Foreign Application Priority Data
Jun. 8, 2010 (TW) 099210903

(51) Int. Cl. H01H 1/10

(52) U.S. Cl. 200/517

(57) ABSTRACT

A press key structure includes a bottom board, an insulating plate, a thin film circuit board, an elastic trigger element, and a keycap covered onto the elastic trigger element, and the insulating plate is installed on the bottom board and includes a penetrating hole, and the thin film circuit board is covered onto the insulating plate, and the thin film circuit board and the bottom board are enclosed to define a containing space at a position corresponding to the penetrating hole, and the thin film circuit board includes a thin film switch disposed above the containing space, and the elastic trigger element is installed above the thin film circuit board, such that external dusts can be prevented from entering into the press key structure from the penetrating hole, and the adverse effect of the dusts on the electric connection and the press path of the press key can be avoided.

### FIELD OF THE INVENTION

The present invention generally relates to a press key structure, in particular to a dustproof press key structure applied to a keyboard.

### BACKGROUND OF THE INVENTION

As computer equipments become popular and network technologies advance, computers are used extensively and become a necessary tool in our life, and a large quantity of electronic information can be distributed quickly via a network through input devices of computer peripherals, and keyboard is one of the popular input devices.

With reference to FIG. 1 for a conventional press key structure 1a of a keyboard, the press key structure 1a comprises a metal substrate 10a, a flexible printed circuit board 20a installed on the metal substrate 10, a conductive circuit 21 printed onto the flexible printed circuit board 20a, a plurality of conductive contacts 22a disposed apart from each other on the conductive circuit 21a, a press key 30a covered onto the top of each conductive contact 22a and provided for conducting the conductive contact 22a by pressing the press key 30a, and an air guide hole 11a formed on the metal substrate 10a and disposed at a position corresponding to the center position of each conductive contact 22a for providing a restoring force when the press key 30a is pressed, and making the operation of the press key structure 1a smoother. However, external dusts or moisture may enter into the press key structure 1a from the air guide hole 11a, or even hinder the pressing path or affect the electric connection of the press key structure 1a.

In the aforementioned structure, although the metal substrate 10a has a viewing plate 40a installed on an external side of the metal substrate 10a, the viewing plate 40a is provided for checking whether or not the press key is installed properly, but not for blocking the air guide hole 11a, so that when small foreign substances such as dusts and moisture enters from the air guide hole 11a, the pressing path and the electric connection of the press key structure 1a are affected.

Since the metal substrate 10a has a plurality of air guide holes 11a corresponding to the plurality of press keys 30a, and the design of the air guide holes 11a reduces the structural strength of the metal substrate 10a, therefore the thickness of the metal substrate 10a cannot be reduced. Furthermore, a stamping mold used for manufacturing the metal substrate 10a also has many air guide holes 11a which reduce the original structural strength and shorten the using life of the mold, and the air guide holes 11a formed by the stamping mold usually have sharp edges, and thus a secondary manufacture of the air guide holes 11a is required to prevent scratching the flexible printed circuit board 20a or other components.

In view of the foregoing shortcomings, the inventor of the present invention based on years of experience in the related industry to conduct extensive researches and experiments, and finally provided a feasible design to overcome the shortcomings of the prior art effectively.

### SUMMARY OF THE INVENTION

Therefore, it is a primary objective of the present invention to provide a dustproof press key structure, wherein a penetrating hole is formed on an insulating plate, and a thin film circuit board and a bottom board are covered on both sides of the insulating plate respectively to prevent external dusts from entering into the press key structure through the penetrating hole.

To achieve the aforementioned objective, the present invention provides a dustproof press key structure comprising a bottom board, an insulating plate, a thin film circuit board, an elastic trigger element and a keycap. The insulating plate is installed on the bottom board and includes a penetrating hole formed on the insulating plate. The thin film circuit board includes a thin film switch covered onto the insulating plate and a containing space defined by enclosing the thin film circuit board and the bottom board at a position corresponding to the penetrating hole. The thin film switch is installed above the containing space, and the elastic trigger element is installed above the thin film circuit board, and the keycap is covered onto the elastic trigger element.

Another objective of the present invention is to provide a dustproof press key structure, wherein if external dusts enter into the press key structure by accident, the containing space is provided for settling the dusts to avoid affecting the electric connection and the pressing path of a press key.

A further objective of the present invention is to provide a dustproof press key structure, wherein the bottom board does not have any opening at the location corresponding to the thin film switch, and thus a thin thickness can be achieved while maintaining a desired structural strength, and the dustproof press key structure can meet the requirements of a light, thin, short and compact design.

Another objective of the present invention is to provide a dustproof press key structure of a keyboard, and the structure does not require any secondary manufacture, and thus the invention can reduce the manufacturing time of the press key.

Compared with the prior art, the dustproof press key structure of a keyboard in accordance with the present invention includes the penetrating hole formed on the insulating plate, and the thin film circuit board and the bottom board are covered on both sides of the insulating plate respectively to prevent external foreign substances such as dusts and moisture from entering into the press key structure through the penetrating hole. In addition, the bottom board and the thin film circuit board are enclosed to define a containing space at the position corresponding to the penetrating hole, such that if external dusts enter into press key structure by accident, the dusts will be settled in the containing space, so that the dusts will not affect the electric connection and the pressing path of a press key. Since the edge of the penetrating hole does not require any secondary manufacture, the manufacturing time of the press key can be reduced. The bottom board does not have any opening at the location corresponding to the thin film switch, so that the structural strength can be maintained and the thickness can be reduced to improve the practicability of the present invention.

### BRIEF DESCRIPTION OF THE DRAWINGS

FIG. 1 is a schematic sectional view of a conventional press key structure of a keyboard;

FIG. 2 is an exploded view of a dustproof press key structure in accordance with present invention;

FIG. 3 is a schematic sectional view of a dustproof press key structure in accordance with present invention;

FIG. 4 is an enlarged view of a portion of FIG. 3; and

FIG. 5 is a schematic view of a preferred embodiment of a dustproof press key structure in accordance with the present invention.

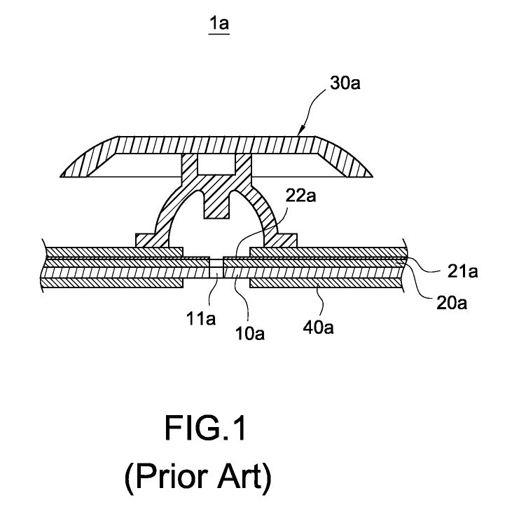

### DESCRIPTION OF THE PREFERRED EMBODIMENTS

The technical characteristics and contents of the present invention will become apparent with the following detailed description accompanied with related drawings, and it is noteworthy to point out that the drawings are provided for the reference and illustration purposes only, but not intended for limiting the scope of the invention.

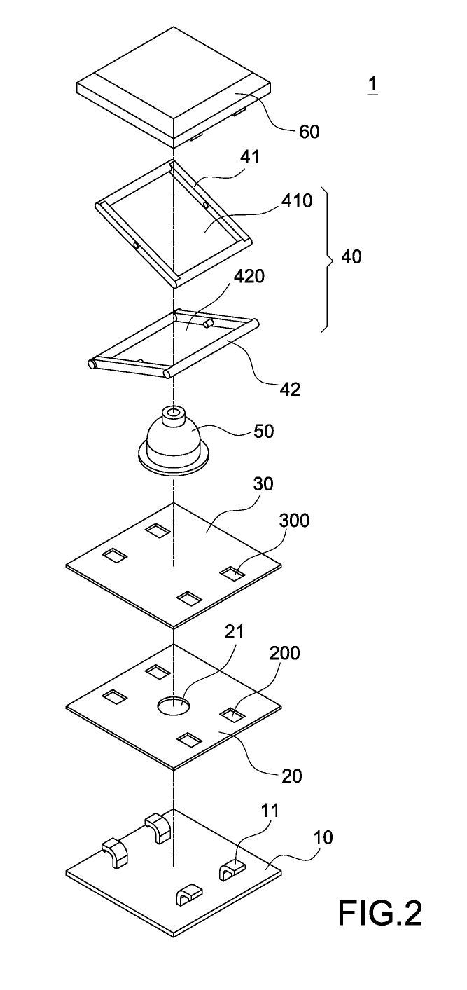

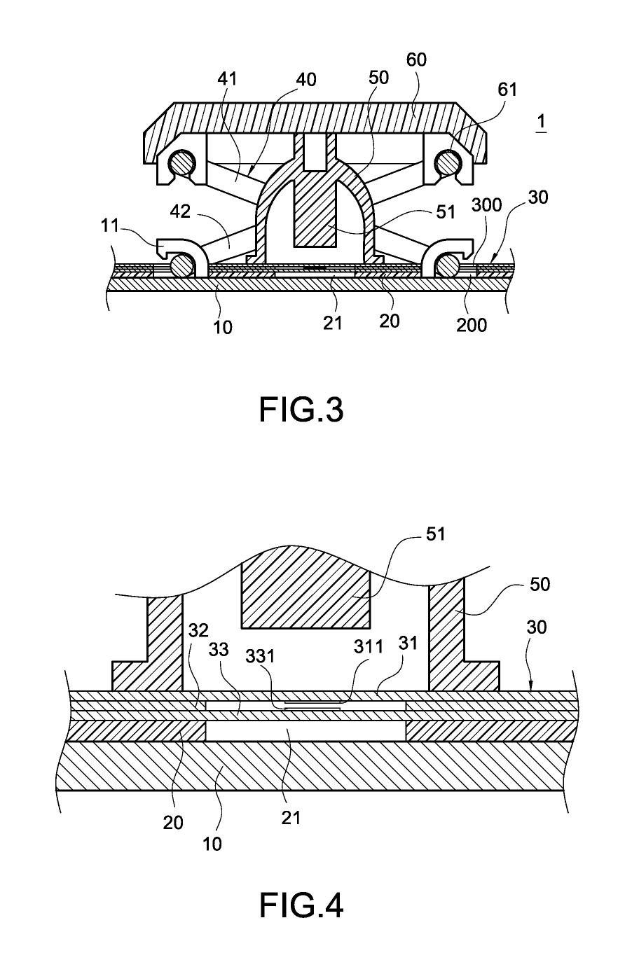

With reference to FIGS. 2 to 4 for an exploded view, a cross-sectional view and a partial enlarged view of a dustproof press key structure in accordance with the present invention respectively, the dustproof press key structure 1 comprises a bottom board 10, an insulating plate 20, a thin film circuit board 30, a bridge mechanism 40, an elastic trigger element 50 and a keycap 60.

The bottom board 10 is a support component, which can be an aluminum board, and the bottom board 10 includes a plurality of positioning portions 11 formed thereon, and the positioning portion 11 of this preferred embodiment is a lug, but any equivalent device can be used for the actual implementation of the invention.

The insulating plate 20 is fixed onto the bottom board 10, and the insulating plate 20 is an extraordinarily strong polyester film such as a Mylar and includes a penetrating hole 21 and a plurality of through holes 200.

The thin film circuit board 30 is covered onto the insulating plate 20 and includes a containing space defined by enclosing the thin film circuit board 30 and the bottom board 10 at a position corresponding to the penetrating hole 21, and a plurality of openings 300 formed on the thin film circuit board 30 and disposed at positions corresponding to the through holes 200 of the insulating plate 20. The thin film circuit board 30 further includes a thin film switch installed at a position corresponding to the penetrating hole 21.

In this preferred embodiment, the thin film circuit board 30 is a three-layer printed circuit board, and includes an anode circuit layer 31, a middle insulating layer 32 and a cathode circuit layer 33, and the thin film switch includes a pair of conductive contacts, and the anode circuit layer 31 includes a conductive contact 311, and the cathode circuit layer 33 includes a corresponding conductive contact 331, and the pair of conductive contacts 311, 331 are formed above the containing space, and the containing space is provided for containing any dust fallen into the press key structure during the manufacturing process or operation to prevent affecting the precision of the electric connection of the press key.

The elastic trigger element 50 is installed above the thin film circuit board 30, and the elastic trigger element 50 of this preferred embodiment is an elastic body made of an elastic material such as rubber, and the elastic trigger element 50 is substantially in the shape of an inverted bowl, and includes a press portion 51 corresponding to a position of pressing the pair of conductive contacts 311, 331. In practical applications, any other equivalent structure can be used for triggering the conductive contact, and the elastic trigger element 50 can be installed at an appropriate position above the thin film circuit board 30, depending on the requirements of a product.

The bridge mechanism 40 includes two frames 41, 42 pivotally coupled with each other into a scissor form, and an opening 410, 420 formed separately on the two frames 41, 42, and the two openings 410, 420 are provided for passing the elastic trigger element 50 through the two openings 410, 420.

The keycap 60 is covered onto the elastic trigger element 50, and the elastic trigger element 50 can provide a position restoring force to move the keycap 60 upward in a moving path of the keycap 60, and a pivot hole 61 is formed separately on both sides of the bottom of the keycap 60, and an end of the two frames 41, 42 is pivotally coupled into the pivot holes 61, and another end is passed through the opening 300 of the thin film circuit board 30 and the through hole 200 of the insulating plate 20 sequentially, and fixed onto the positioning portion 11 of the bottom board 10.

When the press key structure 1 is used, a force is applied to the top surface of the keycap 60, and the bridge mechanism 40 and the elastic trigger element 50 will be pressed by the keycap 60 to move towards the thin film circuit board 30 to define a moving path of the keycap 60. If the press portion 51 of the elastic trigger element 50 is pressed on the thin film circuit board 30, the conductive contacts 311, 331 disposed on the anode circuit layer 31 and the cathode circuit layer 33 of the thin film circuit board 30 will be contacted and conducted with each other, and a press key signal will be fed back to the thin film circuit board 30.

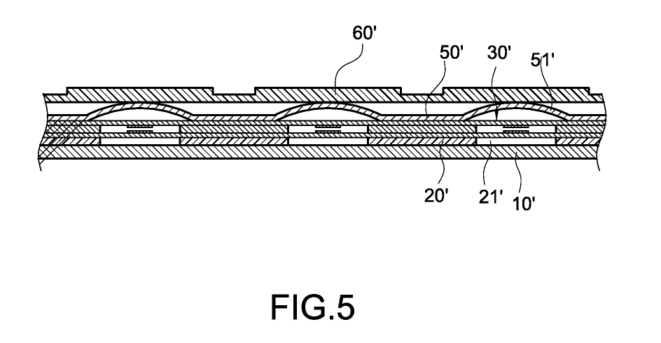

With reference to FIG. 5 for another preferred embodiment of the present invention, this preferred embodiment and the previous preferred embodiment are substantially the same. The press key structure 1′ comprises a bottom board 10′, an insulating plate 20′ with a penetrating hole 21′, a thin film circuit board 30′, an elastic trigger element 50′ and a keycap 60′, and the difference of the two preferred embodiment resides on the elastic trigger element 50′. In this preferred embodiment, a press portion 51′ of the elastic trigger element 50′ is a metal dome sheet, such that when a keycap 60′ is pressed, the corresponding metal dome sheet will be pressed to press the thin film circuit board 30′ below, and a press key signal will be outputted to the thin film circuit board 30′.

While the invention has been described by means of specific embodiments, numerous modifications and variations could be made thereto by those skilled in the art without departing from the scope and spirit of the invention set forth in the claims.

What is claimed is:

1. A dustproof press key structure, comprising:
a bottom board;
an insulating plate, installed on the bottom board, and having a penetrating hole formed on the insulating plate;
a thin film circuit board, including a thin film switch covered onto the insulating plate, and a containing space defined by enclosing the thin film circuit board and the bottom board at a position corresponding to the penetrating hole, and the thin film switch being formed above the containing space;
an elastic trigger element, installed above the thin film circuit board; and
a keycap, covered onto the elastic trigger element.

2. The dustproof press key structure of claim 1, wherein the bottom board is an aluminum board.

3. The dustproof press key structure of claim 1, wherein the insulating plate is a polyester film.

4. The dustproof press key structure of claim 1, wherein the thin film switch is comprised of a pair of conductive contacts.

5. The dustproof press key structure of claim 4, wherein the thin film circuit board is a three-layer circuit board including an anode circuit plate, an insulating layer plate and a cathode circuit plate, and the anode circuit plate and the cathode circuit plate include the corresponding conductive contacts respectively.

6. The dustproof press key structure of claim 1, wherein the elastic trigger element is installed above the thin film switch, and the elastic trigger element includes a press portion corresponding to a position for pressing the thin film switch.

7. The dustproof press key structure of claim 1, wherein the elastic trigger element is made of rubber.

8. The dustproof press key structure of claim 1, wherein the elastic trigger element is substantially in the shape of an inverted bowl.

9. The dustproof press key structure of claim 1, further comprising a bridge mechanism, and the bridge mechanism comprising two frames pivotally coupled with each other into a scissor form.

10. The dustproof press key structure of claim 1, further comprising a bridge mechanism with an end pivotally coupled to the bottom of the keycap, and another end fixed onto the bottom board.

11. The dustproof press key structure of claim 10, wherein the bottom board includes a plurality of positioning portions formed at positions corresponding to the bridge mechanism, and another end of the bridge mechanism is fixed to the positioning portions.

12. The dustproof press key structure of claim 6, wherein the elastic trigger element is a metal dome sheet.
